(19) United States
(12) Patent Application Publication
(10) Pub. No.: US 2008/0296491 A1
(43) Pub. Date: Dec. 4, 2008

(54) METHOD AND APPARATUS TO DETECT CHEMICAL VAPORS

(75) Inventors: Robyn Hannigan, Jonesboro, AR (US); Roger Buchanan, Jonesboro, AR (US); David Clarke, Jonesboro, AR (US)

Correspondence Address: PATRICIA A. SWEENEY, 1835 PLEASANT ST., WEST DES MOINES, IA, 50265, US

(73) Assignee: Arkansas State University Research and Development Institute, State University, AR (US)

(21) Appl. No.: 12/036,509

(22) Filed: Feb. 25, 2008

Related U.S. Application Data
(60) Provisional application No. 60/891,684, filed on Feb. 26, 2007.

(51) Int. Cl. B01D 59/44

(52) U.S. Cl. 250/287

(57) ABSTRACT

Means and method of rapid detection of a compound of interest from an air sample is shown. An air sample is collected, and concentration of the compound of interest can be increased. A portable spectrometer, which preferably is a time-of-flight spectrometer, detects the presence of any of the compound. The system allows for rapid detection of the presence of a compound in an air sample in a field setting.

### REFERENCE TO RELATED APPLICATION

This application claims priority to previously filed and co-pending provisional application U.S. Ser. No. 60/891,684, filed Feb. 26, 2007, the contents of which are incorporated herein by reference.

### GOVERNMENT FUNDING

Work described herein was funded, at least in part, by the federal government, ONR/SMDC, Ref No. ONR W9113M-06-C, and the United States government has certain rights in the invention.

### FIELD OF THE INVENTION

This invention relates to an apparatus configured to allow real-time mass spectral acquisition of chemical vapors (e.g., TNT and derivatives, substances associated with production, shipping and use of illegal drugs and flammable or toxic volatile substances) by direct headspace sampling leading to their detection and identification by miniaturized portable mass spectrometry.

### BACKGROUND OF THE INVENTION

Current real-time time-of-flight mass spectrometry (TOF-MS) instruments are large lab based systems that require sample introduction through gas chromatographic or laser desorption techniques. See e.g., Ermer, U.S. Pat. No. 7,157,701. This reference and all references cited are incorporated herein by reference. Mass spectrometry is a well-known analytical technique for the accurate determination of molecular weights, identification of chemical structures, determination of the composition of mixtures, and qualitative elemental analysis. A mass spectrometer fragments molecules under investigation into ions, separates the ions according to their mass-to-charge ratio, and measures the abundance of each ion. The ion mass is expressed in Daltons (Da), or atomic mass units and the ion charge is the charge on the ion in terms of the number of electron charges.

Time-of-flight (TOF) mass spectrometers separate ions according to their mass-to-charge ratio by measuring the time it takes generated ions to travel to a detector. The flight time of an ion accelerated by a given electric potential is proportional to its mass-to-charge ratio. Thus, the TOF of an ion is a function of its mass-to-charge ratio and is approximately proportional to the square root of the mass-to-charge ratio. Thus ions of a particular mass have the same charge and arrive at the detector at the same time, with the lightest ions arriving first, followed by ions progressively increasing in mass.

Sampling of vapors using existing systems requires obtaining an air sample, collected using a carrier gas, followed by transport to the situs of the spectrometer. Detection of highly dilute vapors in an air sample is difficult using such methods. Further, such lab-based systems are not practical when detection of such vapors in the field is desired, and does not provide for real-time measurements of the components of an air sample. Thus there exists a need for a real-time in-field vapor detection process.

### BRIEF SUMMARY OF THE INVENTION

This invention relates to a method and apparatus to allow real time spectral acquisition of chemical vapors by direct headspace sampling using TOF-MS.

### BRIEF DESCRIPTION OF SEVERAL VIEWS OF THE DRAWINGS

FIG. 1A is a schematic drawing of the sample collection/introduction apparatus illustrating configuration and sample movement during collection phase.

FIG. 1B is a schematic drawing of the sample collection/introduction apparatus illustrating configuration and sample movement during detection phase.

FIG. 2 is a graph showing calibration.

FIG. 3 is a graph showing background air data.

FIG. 4 is a graph showing TNT in the solvent hexane.

FIG. 5 is a graph showing concentration of TNT.

FIG. 6 is a graph showing cluster data.

FIG. 7 is a graph showing cluster data.

FIG. 8 is a graph showing cluster data.

FIG. 9 is a graph showing cluster data.

FIG. 10 is a graph showing mass spectral data for RDX, TNT & PETN

### DETAILED DESCRIPTION OF THE INVENTION

The invention is directed to use of a mass spectrometer combined with an air collection means for obtaining an air sample in the field. The air sample is collected in the field and allows for direct headspace sampling, where the sample may be collected in the field, and in the air space above a surface. The air collection member in one embodiment is combined with a concentration region, allowing the concentration of compounds of interest in the sample to be increased. The concentrated sample is then delivered directly to a portable spectrometer. In one embodiment, a miniature quadrupole GC-MS is used. A preferred embodiment uses a time-of-flight mass spectrometer (TOF-MS). As discussed below, a TOF-MS is preferred because of the inherent sensitivity and selectivity of that type of analyzer, and because use of a mini TOF-MS does not require sample chromatography or carrier gas for sample introduction. The TOF-MS is of a size that it can be transported to the field situs. Combining the miniaturized TOF-MS with the air sampling device and concentrator, a portable chemical detection device is provided that allows for accurate real-time analysis of compounds in an air sample. It further provides for frequent analysis of multiple air samples at a site.

The method and device is useful in detecting any volatile substance in an air sample. When referring to a compound in an air sample that is to be detected is meant any component of an air sample that can be vaporized. The invention thus is useful in many applications. Detection of explosive compounds and components, the presence of illegal substances, air pollutants, toxic compounds are among the many such applications. Multiple military applications are foreseeable; examples include but are not limited to detection of improvised explosive devices (IEDs), also landmine detection, vehicle and individual explosives checkpoints. Examples of vapors that could be detected include but are not limited to: Toluene, hexane, gasoline, acetonitrile, acetone, diethyl ether, methanol, ammonia, chloroform, kerosene, fuels, and other industrial and commercial solvents, and experimental reagents. In an embodiment, it is useful for detecting substances associated with explosive compounds, particularly useful for law enforcement officers and soldiers in the field. Examples of common explosive compounds which can be detected with the invention include, but are not limited to nitrogen-based explosive compounds such as trinitrotoluene (TNT), pentaerythritoltetranitrate (PETN), and cyclotrimethylenetrinitramine (RDX). The system also detects explosives such as, for example, HMX, TATP, ANFO, and DNT. In yet another embodiment, the presence of the components used in making illegal substances such as methamphetamine, or the presence of components of methamphetamine itself may be detected using the invention. These compounds include, for example, kerosene, ammonia, nitrates, and ether. One skilled in the art appreciates the invention is useful in a variety of applications.

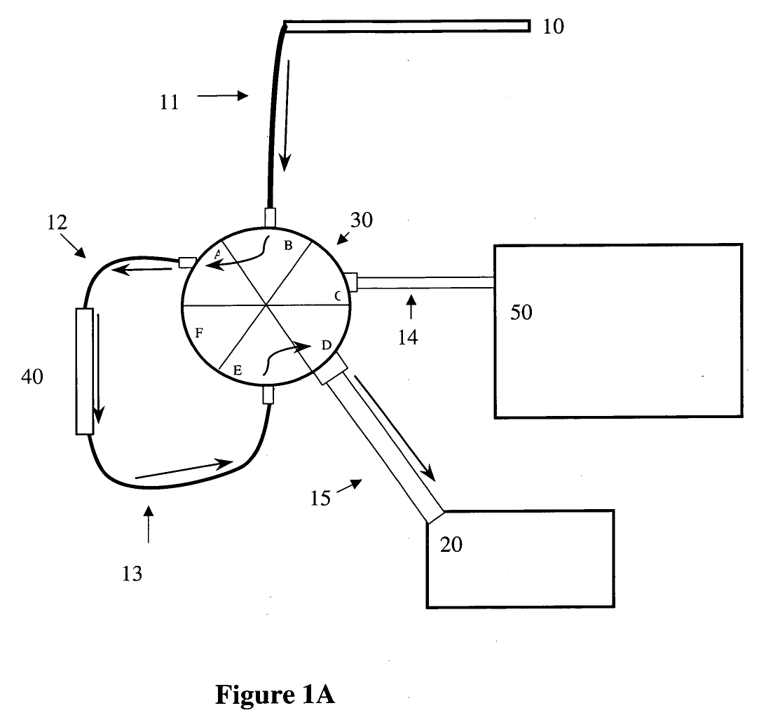

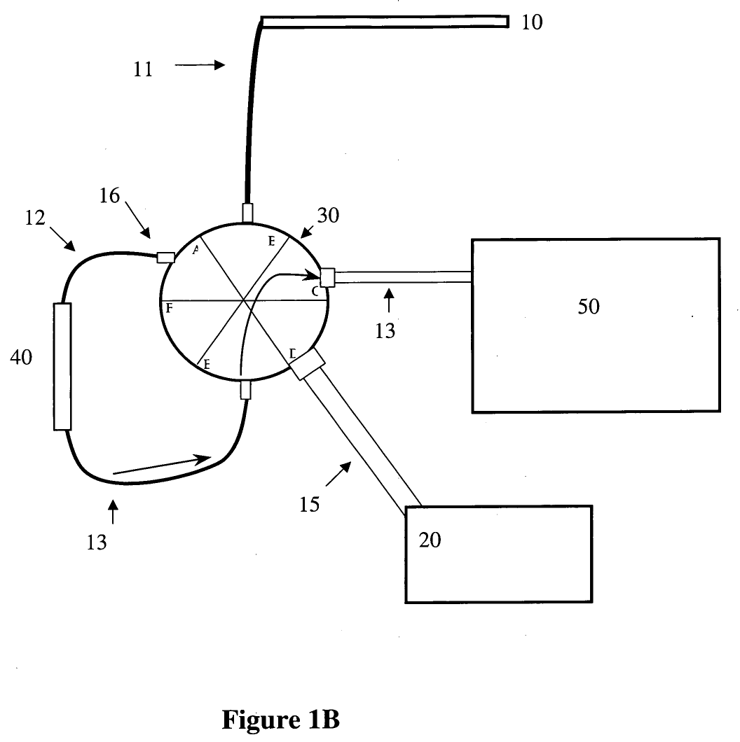

A more complete appreciation of the present invention and many attendant advantages thereof will be readily understood by reference to the following description of an embodiment of the invention. Now referring to FIGS. 1A and 1B, a sample introduction system is shown that can collect a controlled volume of sample and deliver the sample to the TOF-MS detector under controlled sample flow to allow for real-time detection of compounds of interest in the vapor phase. In FIG. 1A, the collection phase of analysis is shown. An air collection member is employed and may take various forms. The air collection member is, in a preferred embodiment, one which does not require the use of a carrier gas to transport the sample from the site of collection to the situs of the mass spectrometer, thus reducing component needed for the device and increasing portability. The member is designed to collect a sample for analysis and can take various forms. Examples include, without limitation, a device providing vacuum suction, or a laser ablation or desorption device which vaporizes the sample.

The device of FIG. 1A shows an embodiment where the collection member uses a collection wand 10 combined with a vacuum pump 20 to pull air containing the volatile compound(s) of interest into a collecting loop 11. The directional arrows show movement of the air sample in the device. A vacuum pump provides a simple, inexpensive and readily transportable air movement source for collecting a sample. The vacuum pump 20 is in airflow connection to the collection wand 10. The collecting wand may optionally incorporate any number of existing or novel collection technologies. For example, any existing fast-gas chromatography sample introduction technology or laser desorption for collecting materials on solid surfaces may be incorporated. In this embodiment an optional multiple port valve 30 is situation between the collection wand 10 and vacuum pump 20. The wand 10 is in sealed airflow connection with the valve 30, shown here by use of a collection loop 11.

The valve is an optional component to aid in directing airflow within the device. It may in another embodiment employ a rotary switch in the valve to aid in directing movement of the air. In the figure a six-port valve is shown, although one skilled appreciates the valve can have any useful number of ports. An example of such a device is a VICI® (Valco Instruments Co. Inc. (Houston, Tex.) Model EDMA electrically operated 6 port valve, but any available multi-port valve could be used. It is only necessary that the valve be capable of directing airflow of volatile(s) being sampled from the collecting member to the concentration region, while preventing its entry into the TOF-MS 50. Here, valve C may be closed during collection phase to prevent entry of the air sample into the spectrometer. After the sample has been concentrated, the switch must be capable of being reconfigured so that sample can move from the concentration region into the TOF-MS. The amount of dead space in the switch should be minimal to allow for efficient sample concentration.

Where the air sample to be collected already has sufficient concentration for detection of the compound of interest such that the spectrometer can register detection of the compound, concentration of the substance may not be necessary. Instead, the air sample may be collected in the field and moved directly to the spectrometer. One skilled in the art appreciates that the sensitivity of the spectrometer to the compound of interest will determine whether concentration in necessary. Where the compound of interest is not sufficiently concentrated to allow detection of the compound, an embodiment provides for a concentrator region in the device.

Where further concentration of the compound is desired, a concentrator region is provided. The concentration region may comprise a concentrator only, or consist of additional components as shown in the figure, including concentrator loops. The figure shows the valve 30 is linked by a concentrator loop 12 or other sealed airflow communication device with the concentrator 40. The concentrator loop can employ any device providing for airflow communication, and in one embodiment is tubing. In an embodiment a ⅛″ stainless steel tubing was employed, but when using tubing, the tube could be made of other metals, plastics or glass depending on the identity of the volatile compounds being detected. The loop 12 is connected to the multiport valve 30 in such a way that sample from the collecting wand 10 enters the loop 12, passes through the concentrator 40 where the analyte of interest is collected. Various means to concentrate pre-selected components of an air sample are known to one skilled in the art and can take different forms dependent upon the volatile compound to be detected. The inventors have found that it is not necessary to have an additional device for separation of the components; rather the concentrator can be employed to both increase the concentration of the compound of interest and remove it from the air sample. A concentrator 40 is a device in which the volatile chemical of interest can be concentrated.

This concentrator may be any number of devices (e.g. a cartridge containing adsorbent resin, glass or plastic beads, a SPME, electrostatic precipitator, etc) suitable for this purpose. One skilled in the art appreciates that the concentrator may employ any technology that provides for the increased concentration of the compound of interest. The following examples of concentrators are presented by way of illustration and not limitation. Tenax™ is an example of an adsorbent resin that is specifically designed to adhere to molecules with a specific subset of physiochemical parameters. (Manufactured by Scientific Instrument Services, Inc. in Ringoes, N.J.; see www.sisweb.com/indes/referenc/tenaxtam.htm.) It is commercially available in a number of different forms—each designed to collect molecules with different properties. (Carbotrap™, Carbosieve™, and Carboxen™ are similar carbon based adsorbent resin manufactures by Supelco Inc/Sigma-Aldrich.) In addition glass beads can be treated so that they behave similarly. Usually adsorbed molecules are released by heating the resin. Alternatively, placing the adsorbent resin under a vacuum will cause the adsorbed molecules to be released. In this application multiple techniques for unloading the resin are possible.

SPME (solid phase microextraction) is an existing technology that is, in principle, similar to adsorbent resins. The difference is that a surface is coated with an adsorbent material. The exact nature of that material varies and is determined by the type of molecule one wishes to adsorb (see, for example, various products by Sigma-Aldrich, St. Louis Mo. and at www.sigmaaldrich.com). In many cases, the SPME material is coated onto a small fiber, however SPME material can be use to coat any appropriate substrate or surface. Like adsorbent resins, adsorbed molecules are usually released by heat, but a vacuum will also work.

An electrostatic precipitator (ESP) is a device used primarily to remove particulates from air. (See International Union of Pure and Applied chemistry, “electrostatic precipitator” Compendium of Chemical Terminology, internet edition, at www.iupac.org/publications/books/author/mcnaught.) One of the most common applications is for pollution control. However, much smaller models are available. An ESP works by establishing a large potential difference that separates particle (molecules in this application) according to charge, i.e. negative molecules will adhere to the positive pole and positive molecules to the negative pole. In this way the collection of molecules can be controlled on the basis of their electrical charge. This, in combination with a vacuum pump, allows concentration of specific molecules into the concentration media. Since the separation process depends on electrical separation a simple phase reversal releases the adhered molecules so that they can enter the TOF-MS.

In one embodiment Tenax™ was used to concentrate samples of dinitrotoluene (DNT) vapor. Vapor was pulled into the collecting wand under vacuum, directed to a Tenax™ filled cartridge for collection and concentration. After a few seconds of vapor collection, the Tenax™-filled collector was heated and the resulting vapor pulled into the TOF-MS by vacuum. In another embodiment toluene was detected by pulling toluene vapor into the collecting wand and introducing the vapor directly into the TOF-MS. In one embodiment it is possible to combine several different concentrating technologies. By way of example, a trap filled with Tenax™ or other adsorbent substance can be used and solid phase micro extraction (SPME) fiber coated with polyacrolate. However, the apparatus could use any trap material, other SPME coatings or concentrating device appropriate to the type of concentrator incorporated into the apparatus and/or the identity of the volatile substances being detected. The degree of concentration desired will vary depending upon the compound to be detected, but typically concentration is increased to at least about 10 times the concentration in the sample, commonly will be increased to at least about 100 times to at least about several hundred times, and can be increased to at least about 10,000 times the original concentration of the compound.

After passing through the concentrator 40, to remove the compound(s) of interest, the remaining air is vented. To achieve continuous sampling (advantageous in several setting, such as when used in a moving vehicle) multiple concentration loops (can concentrators) can be used. In this embodiment as one loop is being concentrated, the contents in the concentrator of another loop are being sent to the detector. FIGS. 1A and 1B illustrates a configuration in which the loop 12 and 13 is vented through the vacuum pump 20, but other venting arrangements could be used. Use of the loops allows for continuous collection and concentration of the substances of interest. For simplicity of illustration, the apparatus is shown with only a single pair of concentrator loops, however, variations could incorporate multiple concentrator loops and/or concentrators so that volatiles that were found in very low concentrations could be collected and concentrated continuously. Multiple loops are advantageous where detection of compounds in multiple air samples is desired in a short period of time, as discussed below. This apparatus is designed to be compatible with collection techniques that depend on carrier gases to move analyte molecules into the concentration loop, but because in the illustrated embodiment the collection loop includes a vacuum pump, collection is not dependent on the use of a carrier gas. While any convenient means of venting the gas remaining after concentration is useful with the invention, in one embodiment, as shown in FIG. 1A, the air sample flows through concentrator loop 13 to port E, where after removal of substances of interest, remaining gas would be drawn through port E of multi-port valve 30, and thence via port D vented through the exhaust or trap of the vacuum pump 20. In this configuration, the outlet (multi-port valve port C) to the TOF-MS 50 is closed so that no sample enters to TOF-MS 50. The concentration region of concentrating loops 12, 13 and concentrator 40, are maintained at a temperature that is conducive to adsorption of substance(s) of interest to the resin or SPME material in the concentrator. In one embodiment, the temperature was kept at room temp (typically about ˜20° C.) because this was best for concentrating DNT. As one skilled in the art appreciates, the exact temperature required will depend on the nature of the volatile substance being collected and the type of concentrator used.

FIG. 1B then shows the detection phase of the process. The concentrated sample is directed to the TOF-MS 50, via a connective means 14, which can be any device in airflow sealed communication with the TOF-MS 50. In one embodiment the TOF-MS device was a Minitof 2 (Comstock, Inc Oak Ridge, Tenn.), but any similar instrument could be used (miniature TOF-MS or miniature GC-MS). Port C is opened so that the sample can flow through connective means 14 into the TOS-MS 50. The sample is pumped into TOF-MS 50 via a vacuum pump which is integral to a TOF-MS. Depending upon the concentrator used, adjustment of temperature of the concentrated sample at this stage may be desired to aid in moving the concentrated sample into the spectrometer. The temperature is such that it optimizes release of the sample so it may be transported to the spectrometer. In one embodiment the concentrator was heated to ˜200° C. to vaporize the DNT adsorbed to the resin. The temperature used will vary depending upon the compounds and concentration substances used, as is known to one skilled in the art. In one example, the temperature selected should be sufficiently high to heat the adsorbing resins or SPME material sufficiently to evaporate the adsorbed material. In another example, if an electrostatic precipitator is used, it may not be necessary to increase the temperature of the collecting loop before allowing the sample to enter the miniature TOF-MS or GC-MS. Air flow communication from the portion of the collection member exposed to ambient air, here the collecting wand 10 and collection loop 11, is closed. In this embodiment it is closed by closing an inlet at 16 at multi-port valve port A, so that only the volatiles in the concentrator 40 and concentrator loops 12, 13 enter the TOF-MS 50. This allows small amounts of volatile sample to be introduced to the TOF-MS in a controlled manner.

This apparatus provides direct headspace sampling through the sampling wand. Direct headspace sampling allows for more accurate analysis of vapor phase chemicals because loss of volatile compounds during transfer in analytical instrument is prevented. This sample introduction system permits chemical vapor sampling to be provided to a TOF-MS for real-time detection of compounds of interest in the vapor phase. The system provides a very rapid in-field system for detecting the presence of a compound of interest. The method and device is capable of a collection time in one embodiment in about one minute or less, in an embodiment about thirty seconds or less and in another embodiment about ten seconds or less. The method and device is capable of detection of any compound of interest in the collected sample in about ten seconds or less and in another embodiment about three seconds or less. The time from collection to detection of any compound of interest will depend in part on whether concentration of the compound of interest is necessary. The method and device is capable of collecting samples about every thirty seconds. The method and device is capable of collecting and detecting any of the compound present in about 15 minutes or less, in another embodiment about ten minutes or less, in a further embodiment about two minutes or less. Where multiple samples are taken, it may be desirable to use multiple concentration loops and/or concentrators. The method and device is capable of providing the user with real-time mass fingerprint data that can be used to identify compounds of interest in the vapor phase.

### EXAMPLE

An existing mini-TOF-MS (C Comstock mini-TOF II) apparatus was filtered with a sample introduction system. In this embodiment, the reaction conditions were:

0.5 mL sample in vial
Sample from headspace for 5 sec into 1 mL sample loop
Filament Current-2.2 Amperes
Detector Voltage-2.5 Kv
Baseline vacuum pressure-2.0 × 10⁻⁵ torr
100,000 sweeps per spectrum
14925.4 Hz-pulse frequency
Time per acquisition-0.67 sec
Pulse Width-35 usec
Total acquisition time-67 sec

Referring to the table above, the device can perform a single “sweep” in nanoseconds. In this sweep a single spectrum is obtained, and multiple sweeps are performed to produce a spectrum with sufficient intensity. The number of sweeps to produce a single spectrum can be controlled by adjusting pulse frequencies. Here, 10,000 sweeps were taken in 0.67 seconds and a million in 67 seconds. Therefore collection time is well below two minutes.

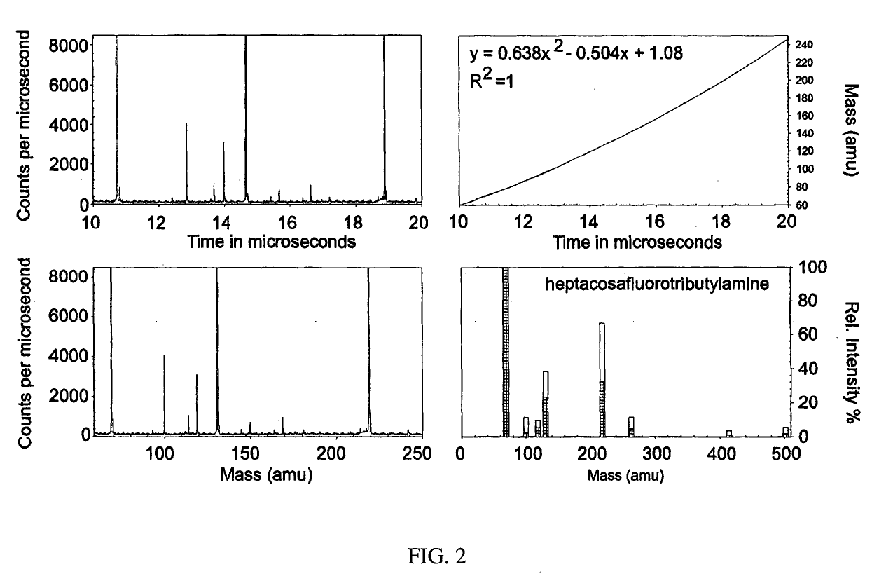

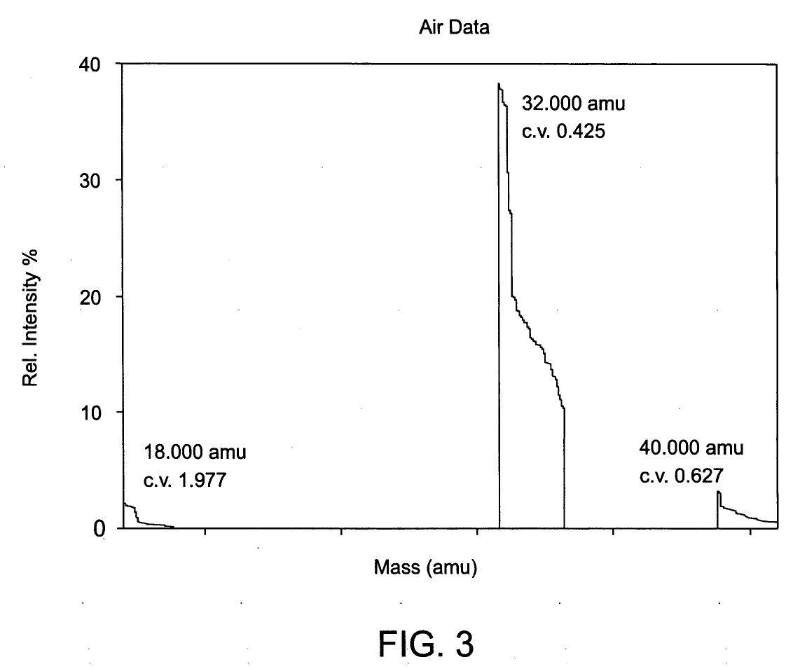

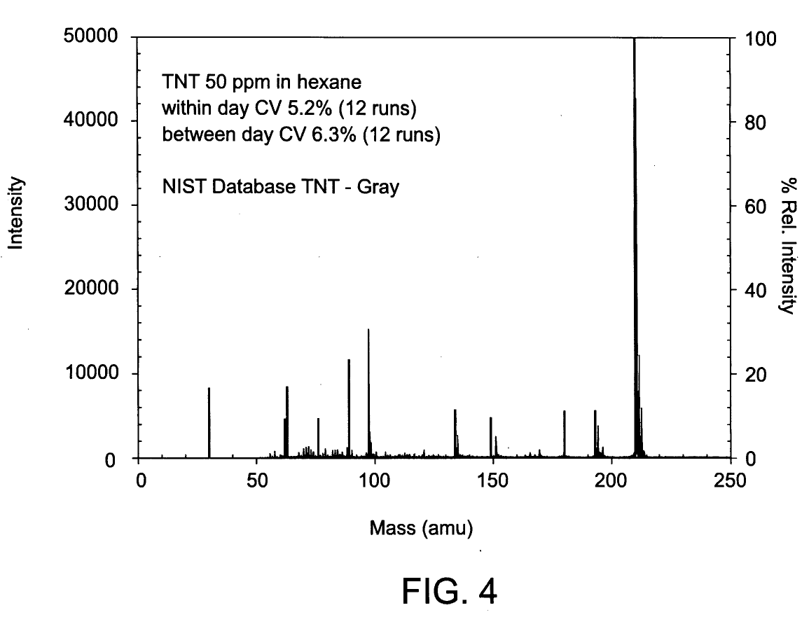

As shown in FIG. 2, the apparatus was calibrated and showed the background data as shown in FIG. 3. Using these configurations, mass spectral data was obtained for TNT, RDX and PETN in various solvents, summarized in FIGS. 4-10.

To test the novel apparatus, an experiment was conducted that was designed to replicate field conditions where trace amounts of analyte are present above the headspace of an explosive. The experiment involved placing a trace amount of explosive in a sealed 1 cubic foot box. Using the known vapor density of these explosives the concentration of the explosive in the air within the box could be calculated. The collecting wand was placed into a small hole in the 1 cubic foot box and a 5 sec sample of the explosive headspace was taken. The negative pressure required for sample collection was produced by a vacuum pump operated under conditions such that sample uptake rate was 1 L/min. Therefore the air sample taken was approximately 85 cubic centimeters of air. As the 85 cubic centimeters of air was pulled through the collection media (in this case the adsorbent resin Tenax™ was used), the trace explosives present in the air were collected and concentrated by adsorption onto the collection media. The valve was then switched to allow the outlet of the sample loop to be connected to the TOF inlet while the collector was rapidly heating (using heat tape wrapped around the collector) to ˜200° C. As the collected and concentrated explosive residue was volatilized from the collection media (the Tenax™ adsorptive resin) it entered the TOF-MS and was detected.

Methods and results are summarized in FIGS. 2-10.

FIG. 2: Mass Calibration.

Data was collected using direct headspace sampling of heptacosafluorotributylamine (hepta). The graphs show the following:
Upper left panel: signal strength vs. time
Upper right panel: Time of flight equation was used to convert time of flight data to mass of the hepta sample.
Lower left panel: “Corrected” intensity of signal for hepta sample after calibration vs. mass
Lower right panel: Mass of hepta vs. relative intensity for repeated measures after calibration. Graph shows results of repeated measures over 48 hrs to verify stability of instrument. Filled bars are data collected on day 1, open bars on day 2. Comparison of the two shows no statistical difference, thereby verifying stability. Data from day 1 compared to data from day 2 using student T test of means and F test of standard deviations. P=0.9138, F value=1.088 indicating that differences between means or standard deviations were not significant.

FIG. 3: Blank Repeatability.

A spectrum of air was collected by direct sampling. 100 samples were collected over 12 hours. Masses shown are 18 (H₂O), 32 (O₂) and 40 (Ar). Coefficients of variation (c.v.) are very low showing that instrument is stable and that measurements are repeatable. All signals were normalized to amu 18 (N₂)

FIG. 4: Spectrum of Trinitrotoluene (TNT) in Hexane Collected by Direct Headspace Sampling.

A headspace sample from a 50 ppm TNT (in hexane) solution was obtained. An average of 24 analyses (12 per day over 2 days) was conducted. Counts were normalized to N₂.

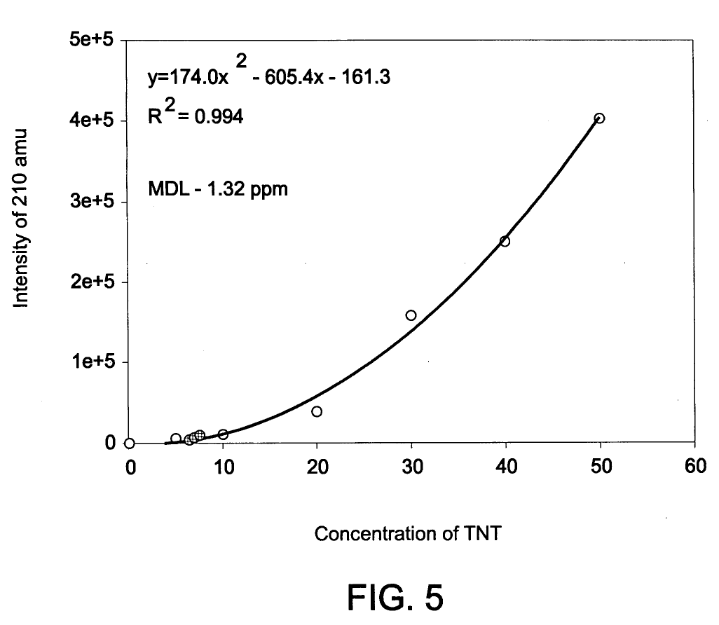

FIG. 5: Response Linearity and Minimum Detection Limit (MDL).

The graph results of direct headspace sampling of 7 different concentrations of TNT (in hexane). Concentrations ranged from 1 ppb to 60 ppb. (MDL was determined using EPA protocol requiring repeated measurement of a 3 ppb solution (TNT in hexane). The MDL shows the excellent sensitivity of this technology. The technology was capable of detecting concentration as low as 1 ppb.

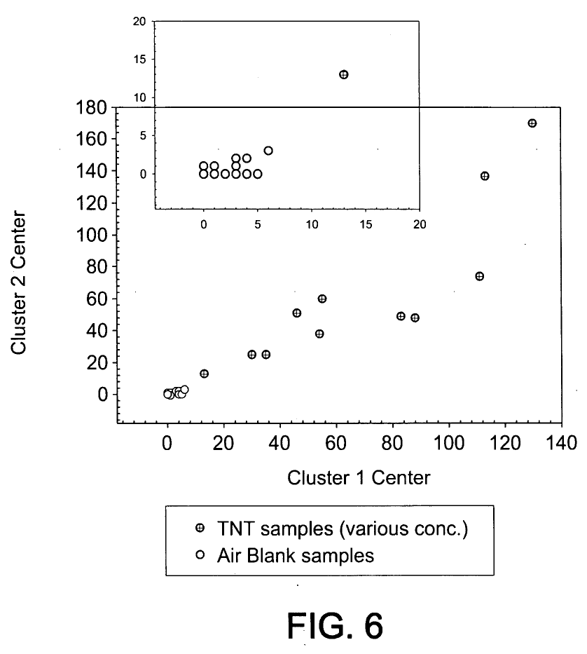

FIG. 6: Cluster Analysis of TNT in Air.

Concentrations of TNT were sampled by direct headspace sampling of various TNT solutions ranging from 0.1 ppb to 50 ppb (filled circles) compared to headspace samples of air that did not contain TNT (open circles). The distinction between the two clusters (compare open circles to filled circles) clearly shows that TNT in air can easily be distinguished from air without TNT using this technology. The Y axis shows cluster distance, the X axis shows concentration (ppb). Clusters centers obtained using this technology are significantly different (K means clustering using Euclidean distance, alpha=0.05.)

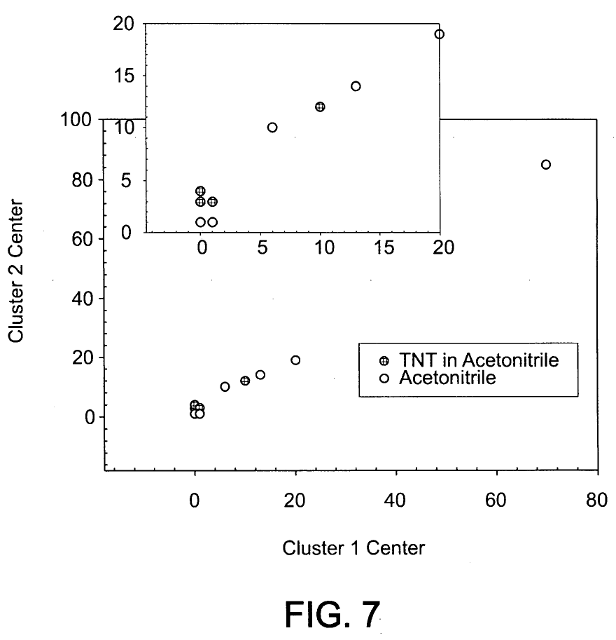

FIG. 7: Cluster Analysis of TNT in Acetonitrile.

Concentrations of TNT sampled by direct headspace sampling of various TNT solutions (in acetonitrile) ranging from 0.1 ppb to 50 ppb (filled circles) to headspace samples of acetonitrile that did not contain TNT (open circles). Cluster analysis clearly shows that TNT in acetonitrile can be easily distinguished from acetonitrile using this technology. The Y axis shows cluster distance, X axis shows concentration (ppb). Clusters centers obtained using this technology are significantly different (K means clustering using Euclidean distance, alpha=0.05.)

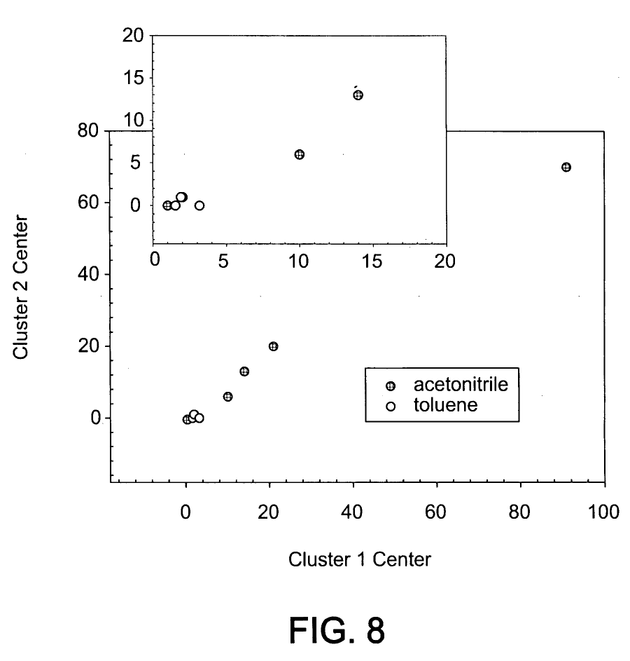

FIG. 8: Cluster Analysis of Two Solvents (Acetonitrile and Toluene) that are Associated with Explosives or Manufacture of Illegal Substances.

Concentrations of acetonitrile and toluene (ranging from 0.1 ppb to 50 ppb) were sampled by direct headspace sampling of various concentrations. Comparison of measured concentrations of acetonitrile (filled circles) and toluene (open circles) clearly shows that the two solvents can be distinguished using this technology Y axis shows cluster distance, X axis shows concentration (ppb). Clusters centers obtained using this technology are significantly different (K means clustering using Euclidean distance, alpha=0.05.).

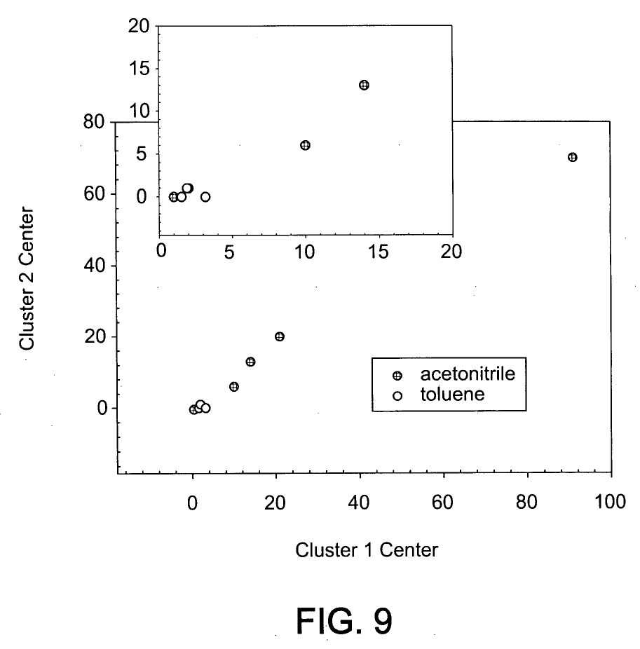

FIG. 9: Cluster Analysis of Three Related Compounds Associated with Explosives in a Mixture.

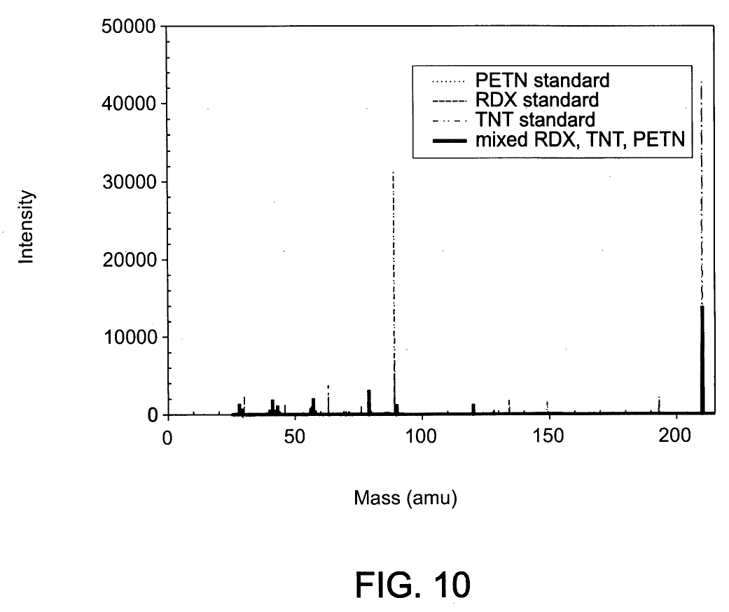

Principle component analysis (PCA) of peak intensities of PETN, RDX and TNT sampled from a mixture of the 3 compounds (see FIG. 10 for spectra) were used to identify unique peaks in statistical space. The eigenvalues (where the individual samples plot in vector space) are plotted here showing that 2 principal components, or 2 unique masses discriminate the explosives (compare clusters of red, yellow and black circles). This figure shows that clusters centers obtained using this technology to detect 3 different closely related compounds in a mixture are significantly different (K means clustering using Euclidean distance, alpha=0.05.).

FIG. 10: Spectra from a Mixture Containing PETN, RDX and TNT.

This figure shows normalized intensities of individual standards containing PETN, RDX or TNT and a mixture of these three explosive-related compounds. As can be seen in the figure the spectra contain overlapping peaks. PCA is a statistical technique widely used for deconvoluting complicated spectra. This technique takes the normalized intensities and mathematically rotates them in vector space so that characteristic ions can be identified. When PCA is applied to these data the spectra of individual compounds can be identified. This figure shows how samples of explosive-related materials plot in vector space and, in combination with FIG. 9, shows that standard statistical techniques can be used to separate and identify the compounds present in the standards and in the mixture.

Other experiments have been done using acquisition times as short as 0.67 seconds, however when sampling from solutions containing small concentrations of analyte, an acquisition time of 6.7 sec was used to obtain sufficient signal to deconvolute complex spectra into individual components (see FIGS. 9 & 10). By concentrating the sample the concentration loop and concentrator (as shown in FIGS. 1A & B) allow for much shorter acquisition times of dilute samples thereby significantly reducing the time needed to acquire spectra of sufficient intensity. Using this concentration technique, sufficient signal can be acquired in as little as 0.67-2 sec.

Although the foregoing invention has been described in some detail by way of illustration and example for purposes of clarity of understanding, it will be obvious that certain changes and modifications can be made which are within the full scope of the invention.

What is claimed is:

1. A method for rapid detection of the presence of a compound in an air sample, the method comprising:
(i) collecting an air sample, and
(ii) detecting the presence of any of the compound in the concentrated air sample with a portable spectrometer,
such the air sample can be collected and any of the compound detected in less than about 15 minutes.

2. The method of claim 1, wherein the air sample is collected such that the collection does not use a carrier gas.

3. The method of claim 1, further comprising increasing the concentration of any of the compound present in the air sample prior to detection of any of the compound.

4. The method of claim 3, wherein the concentration of any of the compound is increased to at least about ten times higher to at least about 10,000 times higher concentration of the compound.

5. The method of claim 1, wherein the air sample is collected from headspace above a surface.

6. The method of claim 1, wherein an air sample can be collected in about one minute or less.

7. The method of claim 1, wherein any of the compound can be detected about ten seconds or less after collection.

8. The method of claim 1, wherein multiple air samples are collected about every 30 seconds.

9. The method of claim 1, wherein the compound is a compound present in a composition selected from the group consisting of an explosive chemical, methamphetamine, or compound used to make methamphetamine.

10. The method of claim 1, wherein the air sample is collected without the need of using a carrier gas, concentration of any of the compound in the air sample is increased to at least about ten times higher concentration of the compound, and the presence of any of the compound in the concentrated air sample is detected with a portable time-of-flight mass spectrometer.

11. A portable air sample compound detection device, comprising an air sample collection member and a portable spectrometer.

12. The device of claim 11, wherein the air sample collection member comprises an air collection device selected from the group consisting of vacuum pump, laser ablation device, laser desorption device, and electrostatic precipitation device.

13. The device of claim 11, further comprising a compound concentration region.

14. The device of claim 13, wherein the compound concentration region comprises a concentrator selected from the group consisting of an adsorbent substance and an electrostatic precipitator.

15. The device of claim 13, wherein the compound concentration region comprises at first concentration loop, a concentrator, and a second concentration loop.

16. The device of claim 11, wherein the portable spectrometer is a time-of-flight mass spectrometer.

17. The device of claim 11, further comprising an air sample-directing valve.

18. The device of claim 11, wherein the air sample collection member comprises an air collection device selected from the group consisting of a vacuum pump, laser ablation device, laser desorption device and electrostatic precipitation device, the spectrometer is a time-of-flight spectrometer, and further comprising at least one air sample-directing valve and a compound concentration region between the sample collection member and spectrometer.

19. A portable air sample compound detection device, comprising means for collecting an air sample, and a spectrometer.

20. The device of claim 19, further comprising a means for concentrating the compound and wherein the spectrometer is a time-of-flight mass spectrometer.
